(19) United States
(12) Patent Application Publication
(10) Pub. No.: US 2014/0087942 A1
(43) Pub. Date: Mar. 27, 2014

(54) PROMOTION OF PLANT GROWTH USING COLLAGEN BASED GELATIN

(71) Applicants: Josep Trias, Palm City, FL (US); Livio K. Takahashi, Braganca Paulista-SP (BR)

(72) Inventors: Josep Trias, Palm City, FL (US); Livio K. Takahashi, Braganca Paulista-SP (BR)

(21) Appl. No.: 13/984,581

(22) PCT Filed: Feb. 10, 2012
(86) PCT No.: PCT/US12/24617

§ 371 Date: Dec. 6, 2013

Related U.S. Application Data
(60) Provisional application No. 61/442,165, filed on Feb. 11, 2011.

(51) Int. Cl. A01C 1/06

(52) U.S. Cl. CPC A01C 1/06
USPC 504/100; 504/275

(57) ABSTRACT

Compositions and related methods for promoting plant growth using irreversibly denatured collagen-based gelatin are described. In one embodiment, a covered plant propagation source comprises a plant propagation source covered by a covering material, the covering material comprising irreversibly denatured collagen-based gelatin. Another embodiment is directed to promoting plant growth by contacting one or more plant propagation sources with irreversibly denatured collagen-based gelatin prior to or during germination of the one or more plant propagation sources.

### CROSS-REFERENCE TO RELATED APPLICATIONS

This application claims priority to U.S. Provisional Patent Application Ser. No. 61/442,165 filed on Feb. 11, 2011 titled “Methods and Applications for the Promotion and Stimulation of Plant Growth with Re-Hydrolyzed Degraded Gelatin (RnH-Gelatin)” the contents of which are incorporated by reference herein in their entirety This application is also a continuation in part of U.S. patent application Ser. No. 12/921,121 filed on Nov. 29, 2010 titled “Capsule, Method for Preparing a Capsule, Method for Packing Biological Material of a Vegetation Source in a Capsule, Culture Cultivation Methods, and Capsule Use,” which is a National Phase Application of International Application Number PCT/BR2009/000056 filed Mar. 6, 2009 with the same title, which claimed priority to Brazil Patent Application Number PI0800365-3 filed Mar. 6, 2008, the contents of which are incorporated by reference herein in their entirety.

### FIELD OF THE INVENTION

The invention relates to compositions and methods for promoting plant growth, and, more particularly, to compositions and methods for promoting plant growth using denatured collagen-based gelatin.

### BACKGROUND

The agriculture industry invests a substantial amount of time and money researching and developing new materials and techniques for improving the yield, health, and quality of planted crops. On one hand, much of the research is directed to developing new chemicals such as fertilizers, fungicides, or insecticides that can be applied to the crop after it is planted. Other research has focused on modifying a plant's genetic material so that the plant is genetically predisposed to be resistant to a certain disease or plant toxin. Unfortunately, both of these avenues have their drawbacks as chemicals for treating plants may adversely affect the environment if not used carefully and there is often a stigma associated with genetically modified plants because they are not well-understood by the public.

It would be beneficial to the agriculture industry to be able to substantially increase the yield and robustness of crops by treating plant propagation sources such as plant seeds or embryos without increasing the use of chemicals or requiring genetically modified plants to do so.

### SUMMARY

The invention advantageously provides compositions and methods for promoting plant growth using irreversibly denatured collagen-based gelatin.

One aspect of the invention is to provide covered plant propagation source product. The covered plant propagation source product comprises a plant propagation source covered by a covering material, the covering material comprising irreversibly denatured collagen-based gelatin. By way of example, suitable plant propagation sources include, but are not limited to, plants seeds or plant embryos. In certain embodiments, the irreversibly denatured collagen-based gelatin has an average molecular weight of between about 300 to about 200,000 Dalton.

Another aspect of the invention is to provide a method of making a covered plant propagation source product. The method comprises obtaining an amount of irreversibly denatured collagen-based gelatin and covering one or more plant propagation sources with a covering composition comprising the irreversibly denatured collagen-based gelatin. Irreversibly denatured collagen-based gelatin may be obtained from raw gelatin, for example, by heating, treating with enzymes, or a combination thereof.

Another aspect of the invention is to provide a method of making a seed pellet with a plant seed therein. The method comprises coating the seed with a coating composition comprising irreversibly denatured collagen-based gelatin and a seed coating powder by wetting the seed coating powder such that the seed coating powder adheres to the seed to form a coated seed and allowing the coated seed to dry.

Another aspect of the invention is to provide a method of promoting plant growth. The method comprises contacting one or more plant propagation sources with irreversibly denatured collagen-based gelatin prior to or during germination of the one or more plant propagation sources.

These and other aspects and advantages of the invention will be better understood in the context of the accompanying drawings and the following detailed description of certain embodiments.

### BRIEF DESCRIPTION OF THE DRAWINGS

FIG. 1 is a diagram of a covered plant propagation source product, wherein the covering material is a hollow capsule with one or more plant propagation sources therein;

FIG. 2 is a cut-away diagram alternative embodiment of a covered plant propagation source product, wherein the covering material is a coating over the plant propagation source;

FIG. 3 is a graph comparing the results of priming butter head lettuce seeds with irreversibly denatured collagen-based gelatin (“FL”) versus priming with PEG;

FIG. 4 is a graph comparing the results of priming iceberg head lettuce seeds with irreversibly denatured collagen-based gelatin (“FL”) versus priming with PEG;

FIG. 5 is a graph comparing the results of priming crisp lettuce seeds with irreversibly denatured collagen-based gelatin (“FL”) versus priming with PEG;

FIG. 6 is a bar graph showing the effect of priming sweet pepper seeds with irreversibly denatured collagen-based gelatin;

FIG. 7 is a bar graph showing the results from the first harvest of a tomato crop, wherein the tomatoes seeds were present in capsules comprising irreversibly denatured collagen-based gelatin; and

FIG. 8 is a bar graph showing the box weight per 1000 plants after the fourth harvest of the same tomato plants as in FIG. 7.

### DETAILED DESCRIPTION OF CERTAIN EMBODIMENTS

In the Summary above and in the Detailed Description of Certain Embodiments and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

The term “comprises” is used herein to mean that other ingredients, steps, etc. are optionally present. When reference is made herein to a method comprising two or more defined steps, the steps can be carried in any order or simultaneously (except where the context excludes that possibility), and the method can include one or more steps which are carried out before any of the defined steps, between two of the defined steps, or after all of the defined steps (except where the context excludes that possibility).

In this section, the present invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art.

Collagen is a class of naturally occurring proteins found primarily in the flesh and connective tissue of animals. It is the most abundant protein in mammals. The collagen molecule, also called tropocollagen, is made of three polypeptide strands that form a triple helix structure. The amino acids in each of the three polypeptide strands are arranged regularly with proline, hydroxyproline, and glycine being the most prevalent. It is believed that glycine is required at every third position to help support the triple helix structure. Collagen is typically extracted from a source such as bovine tissue, porcine tissue, or fish tissue using a thermal, acid, base, or enzymatic extraction process.

The extracted collagen can be broken down through hydrolysis to form what is called hydrolyzed collagen or gelatin. During the hydrolysis process the bonds between individual collagen strands are broken down into a form that re-arranges more easily with the recovery of the native collagen structure.

Denaturation is a process in which a protein loses the tertiary and secondary structure that was present in the protein's native form. Proteins may be denatured thermally by applying heat or chemically by applying an acid, base, concentrated inorganic salt, organic solvent, or enzymes. In general, these processes destabilize the protein's native structure by breaking bonds in the protein, including breaking the hydrogen bonds that stabilize the tertiary and secondary structure.

The inventors advantageously found that when collagen-based gelatin is irreversibly denatured, the irreversibly denatured collagen-based gelatin can function as a plant growth promoter. As used herein, the term “irreversibly denatured” means that the gelatin has been denatured to the extent that it can no longer recover its native protein structure. Plants that were treated at some stage of development with irreversibly denatured collagen-based gelatin showed increased size and yield versus plants that were not treated with irreversibly denatured collagen-based gelatin.

Commercially available collagen-based gelatin is not a plant growth promoter. The inventors found that conventional collagen-based gelatin as processed and used in the food and pharmaceutical industries and in industry generally, does not measurably affect plant growth. Advantageously, however, the inventors found that, depending on the embodiment used, irreversibly denatured collagen-based gelatin may provide one or more of the following benefits: increasing the rate of plant growth, improving plant health, increasing plant weight (both fresh and dry), and increasing plant yield.

According to an aspect of the invention, commercially purchased collagen-based gelatin (“raw gelatin”) is irreversibly denatured so that it may be used as a plant growth promoter. Preferably, the raw gelatin is thermally denatured, chemically denatured, enzymatically denatured, or a combination thereof.

A preferred process for denaturing raw gelatin generally comprises diluting powdered or granular raw gelatin in a solvent such as water. The diluted raw gelatin is then heated to a desired temperature for a predetermined period of time and allowed to denature. After that period of time, the denatured gelatin is cooled to a desired cooling temperature. The heating and cooling cycle may be performed a single time or may be repeated many times. The number of times the heating and cooling cycle is repeated often depends on the commercial source of the gelatin and the level of denaturation that is desired. The raw gelatin may also be denatured through an enzymatic process alone or in combination with heating. Ideally, the denaturing process is adapted to break down the raw gelatin's native structure into individual polypeptides, amino acids, or combinations thereof that are responsible for promoting plant growth.

Another preferred process for denaturing raw gelatin comprises diluting the gelatin in water to form a raw gelatin solution, allowing the raw gelatin to dissolve, heating the raw gelatin solution to a desired temperature, holding the raw gelatin solution at the desired temperature for a predetermined period of time, and cooling the gelatin solution to a predetermined cooling temperature. This process may be repeated as many times as desired. Preferably the % of gelatin per liter of water in the raw gelatin solution is in the range of about 5% to about 50% and more preferably about 10% to about 25%. The raw gelatin is preferably allowed to dissolve at or near room temperature, preferably at about 25° C., for an extended period of time. A preferred dissolution time is in the range of about 6 to about 24 hours. Preferably, the raw gelatin solution is heated to between about 30° C. to about 200° C. for several hours. A preferred heating time range is about 1 to about 72 hours. A preferred temperature range for cooling the heated gelatin solution is about 25° C. to about 75° C. and more preferably about 30 to about 55° C.

Another preferred process for denaturing collagen-based raw gelatin is now described. Water is heated to 25° C. and raw gelatin is added at a ratio of 16 kg of raw gelatin per 100 L of water. The raw gelatin is allowed to dissolve for 24 hours. During this time the raw gelatin swells. After 24 hours, the raw gelatin solution is heated to between 60 and 90° C. for more than 1.5 hours. Afterwards, the solution is allowed to cool.

If desired, the polypeptides obtained from thermally denaturing the raw gelatin as described above can be further broken down to shorter polypeptide sequences by contacting the thermally denatured gelatin with peptidase enzymes, pepsin, oxidase enzymes, collagenase enzymes, bromelin, protease enzymes, aminase enzymes, or combinations thereof. Protease enzymes are enzymes that cleave peptide bonds. Preferred molecular weight ranges for the further broken down polypeptides are between about 300 Dalton to about 200,000 Dalton or about 300 Dalton to about 5000 Dalton. If enzymes are used, they may be added at a rate of, for example, about 1 g to about 50 g/kg of gelatin. In a typical embodiment, they are added to a solution of thermally denatured gelatin. That solution is then heated to about 75° C. for about 6 to about 72 hours to allow digestion to take place. The resulting irreversibly denatured collagen based gelatin may then be dried if desired or left dissolved in the solution. Optionally, polyhydric alcohols such as glycerol, sorbitol, or the like are also possible to use for further denaturization.

As will be discussed in the Examples, after the irreversibly denatured collagen-based gelatin is treated with the peptidase enzymes, the amino acids glycine, hydroxyproline, and proline comprise the highest relative % w/w of the amino acids in the polypeptide sequences. Typically, hydroxyproline comprises about 12% to about 13% w/w, glycine comprises about 21% to about 22% w/w, and proline comprises about 12% to about 13% w/w of the polypeptide sequences in the sample.

Once the denaturing process is complete, the irreversibly denatured collagen-based gelatin does not form a gel when in an aqueous solution. Preferably, the irreversibly denatured collagen-based gelatin is removed from the aqueous solution by drying such that the irreversibly denatured collagen-based gelatin forms a solid crust, powder, or the like. Advantageously, the solid irreversibly denatured collagen-based gelatin can be reconstituted in water, but without forming a gel, when concentration is between about 1% to about 70%. This allows the irreversibly denatured collagen-based gelatin to be easily applied to a plant material for promoting plant growth.

The irreversibly denatured collagen-based gelatin is applied as covering material to a plant propagation source to form a covered plant propagation source product. In one embodiment, the covered plant propagation source product comprises a plant propagation source covered by a covering material, the covering comprising the irreversibly denatured collagen-based gelatin for promoting plant growth. The plant propagation source may be one or more plant seeds, one or more plant embryos, or a combination thereof.

The covering material may be in the form of a coating over the plant propagation source. Suitable coatings include but are not limited to seed pellet coatings, films, or encrustments. The covering material may alternatively comprise a hollow capsule similar to a conventional gelatin capsule, except that at least a portion of the gelatin is irreversibly denatured collagen-based gelatin.

It is preferred that the covering material allows water to transport the irreversibly denatured collagen-based gelatin in such a way that the irreversibly denatured collagen-based gelatin contacts the plant propagation source. This allows the polypeptides, peptides, and amino acids in the irreversibly denatured collagen-based gelatin to contact the plant propagation source.

The covering material may further comprise one or more active ingredients such as fertilizers, fungicides, insecticides, biocides, herbicides, growth promoters, hormones, markers or combinations thereof.

As non-limiting examples, the following are a list of active ingredients that may be used in accordance with embodiments of the invention: disulfoton, Fipronil, Clothiamidin, Lindane, Methiocarb, Fipronil, Phoxim, Bendiocarb, Benfuracarb, Diazinon, Imidacloprid, Furathiocarb, Isazofos, Thiametoxam, Pirimiphos-methyl, Acephate, Thiacloprid, Fosthiazate, Cyfluthrin+Imidacloprid, Terbufos, Dimethoate, Cypermethrin+Thiamethoxam, Methamidophos, Methaldehide, Vamidothion, Carbosulfan, Methomyl, Monocrotophos, Bitertanol, Carboxin, Diniconazole, Ethirimol, F500/Bosaliol, Fenitropan, Fenpiclonil, Fludioxonil, Flutriafol, Fuberidazole, Guazatine, Hexaconazole, Imazadil/Imazalil, Iminoctadine, Iprodione, Methfuroxam, Nuarimol, Niclosamid, Oxine Copper, Thiodicarb, Oxycarboxin, Quintozene, Tebuconazole, Tetraconazole, Thiabendazole, Triadimenol,Fludioxonil, Triticonazole, Etridiazole, Metalaxyl, Pencycuron, Methyl Tolclofos, Thiram, Benalaxyl, Captan, Tritosulfuron, Oxadixyl/Oxydixyl, Tolciofos-methyl, Validamycin, Hymexazol, Oxolinic acid, Tefluthrin, Tebupirimfos, Pefurazoate, Pyroquilon, Tecloftalam, Propamocarb, Trifumizole, Triflumizole, Fosetyl cyproconazole, Carboxin+thiram, Cartboxin+thiran, acibenzolar-S-methyl, disulfoton+triadimenol, acibenzolar-S-methyl, carbendazim+chlorothalonil, metconazole, cartap, thiophanate-methyl, chlorothalonil+thiophanate-methyl, bromuconazole, fenpropimorph, cymoxanil+mancozeb, carbendazim+thiram, mancozeb+thiophanate-methyl, cymoxanil+famoxadone, chlorothalonil+metalaxyl-M, pyroquilon, dimethomorph, benalaxyl+mancozeb, kasugamycin, oxycarboxin, flutriafol, propiconazole, quintozene, imibenconazole, fludioxonil+metalaxyl-M, epoxiconazole+pyraclostrobin, epoxiconazole, fluquinconazole, oxycarboxin, triticonazole, fenarimol, triforine, difenoconazole, flutriafol, propiconazole+trifloxystrobin, kresoxim-methyl thiabendazole, triflumizole, cyprodinil, procymidone, propiconazole+trifloxystrobin, kresoxim-methyl, thiabendazole, triflumizole, cyprodinil, flutriafol, and combinations thereof.

Also, a combination of fungicides and insecticide-like products as such as FarMore D200 (Mefenoxam and Fudioxinil), Captan (N-trichloromethyl thio-4-cyclohexane-1,2-dicarboximide), Thiram (Proseed), FarMore D300 (Azoxystrobin, Mefenoxan and Fluidioxomil) or FarMore DI 400 (Thiamethoxam, Azoxystrobin, Methenoxam and Fludioxomil) from Harris Moran, or combinations of F500 (as Headline or Opera) and Bosalid, Tritosulfuron, Metalaxyl, Chlorfenapyr, Dimoxystrobin, Metrafenone, Orystrobin, Topramezone and Metaflumizone from BASF alone or combined with StompAqua (Prowl H2O) o. The Serenade or Serenade Max line also from BASF, is also possible to use. Spinosad and Cruiser (both from Syngenta) as FarMore FI500 seed treatment can also be added, also Maxim (Fludioxonil+Mefonoxam), Dividend 3FS (difenoconazole), Apron (Mefonoxan), Rovral (carbendazime iprodione), all alone or combined to up to concentrations of about 10% w/w.

As non-limiting examples, the following are a list of biocides that may used in accordance with embodiments of the invention: Hypochlorite, Chlorine and Chlorine gas, Methicillin, Tetracyclins, Ampicillins, Penicillins, Hydantoin, Hypochlorous Acid, Sodium Dichloro-S-Triazinetrione, Trichloro-S-Triazinetrione, Copper alloys, Vircon, Hydrogen Peroxide, Oxolinic Acid, Ammonia, or Herbicides such as Roundup.

As non-limiting examples, the following are a list of growth promoters that may be used in accordance with embodiments of the invention: Ethephon, Ethrel, Ethylene, Humic Acid, Alginates, Peat Most, Potassium Nitrate, chelates, Magnesium Suphate, macro and micro plant nutients and fertilizer.

As non-limiting examples, the following are a list of hormones that may used in accordance with embodiments of the invention: Gibberilic Acid, kinetin's, Naphthalene-Acetic Acid, Cytokinin, Ethylene, Abscise Acid, Auxins, Indole Butyric Acid, or combinations thereof.

As non-limiting examples, the following are a list of markers that may used in accordance with embodiments of the invention: one or more of Rhodamine, Diazonium salts, Anthraquinone, Coumarin, Thriphrnylmethane, phthalocyanine, natural and artificial nanoparticles, or pigments, including mica pigments.

If peptidase, collagenase and protease enzymes are used in the denaturation process, the covering material may also comprise peptidase, collagenase, protease enzymes, or combinations thereof.

In certain embodiments, other enzymes may be used alone or in combination with each other or peptidase enzymes. Examples include, but are not limited to, aminases, pepsin, bromelin, and oxidases.

In certain embodiments, the covering material comprises irreversibly denatured collagen-based gelatin, wherein the irreversibly denatured collagen-based gelatin has an average molecular weight of about 300 to about 200,000 Dalton, about 500 to about 5,000 Dalton, or about 300 to about 5,000 Dalton.

In a preferred embodiment, the covering material is used to encapsulate one or more plant propagation sources. This may be accomplished by preparing a capsule into which a plant propagation source can be placed or by incorporating the irreversibly denatured collagen-based gelatin into a seed pellet.

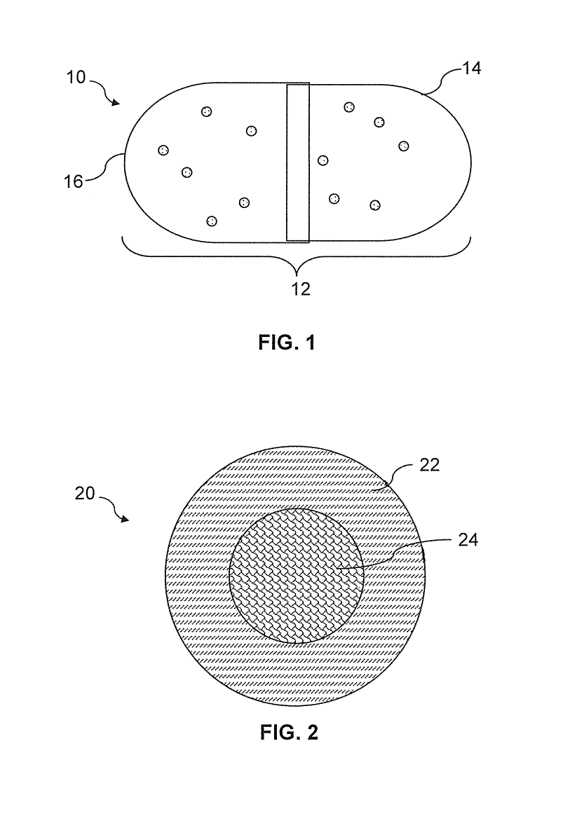

Referring to FIG. 1, an embodiment of a covered plant propagation source product 10 comprises a covering material is a hollow capsule 12 with one or more plant propagation sources therein. In this embodiment, the hollow capsule 12 has a structure similar to a conventional gelatin capsule having a first capsule portion 14 that interconnects with a second capsule portion 16 by partially placing the first capsule portion 14 within the second capsule portion 16.

Referring to FIG. 2, an alternative embodiment of a covered plant propagation source product 20 comprises a covering material, wherein the covering material is a coating 22 over the plant propagation source 24. The coating may be in the form of a film, encrustment, or the like. The plant propagation source product 20 of FIG. 2, may be used alone or in combination with that of FIG. 1.

In an embodiment of the invention, the covered plant propagation source product 20 is a seed pellet, wherein the plant propagation source 24 is coated with seed pelleting material, having irreversibly denatured collagen-based gelatin therein.

The seed pelleting material may include a seed pelleting powder. Preferably, the seed pelleting powder includes one or more inert materials with at least one of the inert materials having a high surface area. Suitable materials for the seed pelleting powder include, but are not limited to: clays, diatomaceous earth, perlite, pumice, quartz, talc, bentonite, mica, metal stearate, metal laureates, metal palmitates, metal saturated fats, silica fumed, silica fume water repellants materials (Cab-O—Sil TS530), smectite, montmorillonite, feldspars, kaolin, antifoaming agents, glycerin, alcohols, silicone, carbonates, zeolites, fertilizers, harpins, wood powder, glass spherules, starch, cellulose, or combinations thereof. By way of example only, good results have been obtained with the seed pelleting powder CS-MJ-05 or the REG-510 series, which can be purchased from Coating Supply, Inc, 2017 SW Mooring Drive, Palm City, Fla. 34990.

Materials such as water repellents, water absorbents, pigments, markers, tracers, acids, salts, or a combination thereof may also be used.

Another aspect of the invention is to provide a method of making a covered plant propagation source, comprising obtaining an amount of the irreversibly denatured collagen-based gelatin and covering one or more plant propagation sources with a covering material made at least in part of the irreversibly denatured collagen-based gelatin. The irreversibly denatured collagen-based gelatin may be obtained as described above. Covering may mean placing the one or more plant propagation sources into a hollow capsule, coating the one or more plant propagation sources with the covering material, or a combination thereof.

Another aspect of the invention is to provide a method of making a seed pellet with a plant seed therein. This method comprises coating the seed with a coating composition comprising irreversibly denatured collagen-based gelatin and a seed coating powder by wetting the seed coating powder such that the seed coating powder adheres to the seed to form a coated seed. The coated seed may then be allowed to dry to form a seed pellet. The coating composition may be present in a solid form during coating. Alternatively, wetting may be achieved by applying a solution of the coating composition to the seed coating powder. A suitable seed coating powder is a seed pelleting powder as previously discussed.

Two exemplary processes for incorporating irreversibly denatured collagen-based gelatin into a seed pellet will now be discussed. In the first process, the irreversibly denatured collagen-based gelatin serves as the binder for the seed pelleting powder. In the second process, the irreversibly denatured collagen-based gelatin forms a portion of the seed pelleting powder.

Seed pellets comprising irreversibly denatured collagen-based gelatin may be made by modifying conventional seed pelleting techniques. In general, seed pellets are produced by loading seeds into a coating pan or rotary seed coating machine. A seed pelleting powder is selected and added to the seeds. The seeds and seed pelleting powder are mechanically mixed while water or binder is added. Each seed is encapsulated in a layer of the wetted seed pelleting powder. To increase the thickness of the coating, additional seed pelleting powder and water or binder are added. Typical seed pellets have diameters in the about 0.9 mm to several mm range. Although the size of the seed pellets are not limiting, the inventors have been able to achieve good results with vegetable seed pellets ranging from about 3 to about 3.5 mm in diameter.

During the pelleting process, one or more additives such as one or more binders or excipients may be used. Examples of suitable binders include, but are not limited to, polymers such as polyvinyl pyrrolidone, polyvinyl alcohol, or polyvinyl acetone and cellulose derivatives such as methylcellulose, arabic gum, casein, gelatin, sodium alginate, polyethylene wax, paraffin wax, acrylic copolymers, dextrin, polysaccharides (starch), fats, oils, celluloses and syrups. The binder is typically diluted with water and applied in a later stage of the process. The binder may be applied, for example, through a spray gun when using a coating pan or through an atomizer when using the rotary pelleting machine.

In a preferred embodiment, the binder comprises irreversibly denatured collagen-based gelatin with or without the additional active ingredients. A process for making seed pellets utilizing irreversibly denatured collagen-based gelatin comprises preparing a mixture of seeds and seed pelleting powder, applying water to the mixture, mixing the wet mixture to allow the seed pelleting powder to form a layer over each of the seeds, adding additional seed pelleting powder, and applying irreversibly denatured collagen-based gelatin. The steps of adding additional seed pelleting powder and applying irreversibly denatured collagen-based gelatin can be repeated until the seed pellet reaches the desired thickness and desired size. Advantageously, the irreversibly denatured collagen-based gelatin not only binds the outer layers of the seed pellet, but also promotes plant growth.

In another preferred embodiment of the invention, the irreversibly denatured collagen-based gelatin is applied in powder form along with seed pelleting powder. For this embodiment, the irreversibly denatured collagen-based gelatin is prepared as described above, filtered, and dried. Compressed air may be used to aid in drying. In this case the preferred heating temperature range for the raw gelatin is about 70° C. to about 200° C. for a preferred time of about 0.5 hr to about 48 hours. The dried irreversibly denatured collagen-based gelatin is pulverized to a powder, preferably with particulate sizes of 80 mesh or smaller or a particulate size of 300 mesh or smaller. The powder is then applied to the seeds in a similar manner to the seed pelleting powder as described above. A preferred concentration of powdered irreversibly denatured collagen-based gelatin to seed pelleting powder is from about 1% w/w to about 50% w/w, or about 1% w/w to about 20% w/w, or about 1% w/w to about 5% w/w. It is notable, however, that the concentration may be even higher (up to 100%).

The inventors also advantageously found that when the irreversibly denatured collagen-based gelatin is applied to a plant propagation source before or during germination, such as when seed embryo cells are initiating their activity and the number of embryonic cells is small compared to when the plant is fully formed, the irreversibly denatured collagen-based gelatin substantially enhances plant growth.

Although not intending to be bound by theory, it is believed that, during the germination phase, the embryonic cells become activated by the polypeptides in the irreversibly denatured collagen-based gelatin and, if present, the protease, collagenase, peptidase, oxidase or aminase enzymes in the covering composition. When the irreversibly denatured collagen-based gelatin is applied to the plant propagation material in a post-embryonic environment, it does not measurably affect plant. It is also believed that the availability of water during the embryonic phase and the first stages of plant growth, when the seed is germinated or cell division is initiating, may be an important factor in enhancing the growth promotion effects of the irreversibly denatured collagen-based gelatin.

In the agriculture industry it is common for seeds to be primed before they are sown in order to improve germination. The typical osmotic priming medium is a polyethylene glycol (“PEG”) medium, such as PEG 6000 or PEG 8000. The inventors found that irreversibly denatured collagen-based gelatin may be used in combination with or in the place of PEG as a priming agent.

When used as the priming agent, the irreversibly denatured collagen-based gelatin of the invention provides the added advantage that its plant growth enhancing properties can be re-activated by applying irreversibly denatured collagen-based gelatin to the plant in a later growth stage.

According to another aspect of the invention, a method of promoting plant growth comprises contacting one or more plant propagation sources with irreversibly denatured collagen-based gelatin prior to germination of the one or more plant propagation sources. The term “contacting” is intended have its typical meaning, which for the sake of illustration includes applying a solution containing irreversibly denatured collagen-based gelatin to the plant propagation source as one would typically contact the plant propagation source when priming with PEG or placing a liquid containing irreversibly denatured collagen-based gelatin in contact with the one or more plant propagation sources such as by spraying, pouring, or the like.

In a particular embodiment, contacting comprises soaking the one or more plant propagation sources in irreversibly denatured collagen-based gelatin prior to sowing the one or more plant propagation sources. After plants grow from the one or more plant propagation sources, the growth enhancing effects of the irreversibly denatured collagen-based gelatin may be re-activated by contacting the plant with additional irreversibly denatured collagen-based gelatin. This may be accomplished for example, by watering the plant with an aqueous solution containing irreversibly denatured collagen-based gelatin.

After the plant propagation sources are primed, it may be useful to cover the previously primed plant propagation sources with a covering material comprising irreversibly denatured collagen-based gelatin as described above.

### EXAMPLES

In this section, examples of seed pellets comprising irreversibly denatured collagen based gelatin are presented. The specific examples are provided for illustrative purposes only and are not limiting in any way.

### Example 1

### Determination of the Amino Acid Components in Compositions of the Invention

Three samples of irreversibly denatured collagen-based gelatin were prepared as described above. The resulting samples were then analyzed for their amino acid content. The relative amino acid content of Samples 1-1, 1-2, and 1-3 are provided in Table 1.

TABLE 1
Compositional Analysis (%)

| | Sample 1-1 | Sample 1-2 | Sample 1-3 |
|---|---|---|---|
| OH-PRO | 12.60 | 12.68 | 12.67 |
| ASP | 5.53 | 5.50 | 5.51 |
| SER | 3.20 | 2.93 | 2.88 |
| GLU | 11.14 | 11.67 | 11.49 |
| GLY | 21.25 | 21.29 | 21.82 |
| HIS | 1.37 | 1.47 | 1.92 |
| NH3 | 0.43 | 0.43 | 0.42 |
| ARG | 7.87 | 7.88 | 7.63 |
| THR | 1.88 | 1.87 | 1.82 |
| ALA | 8.24 | 8.20 | 7.96 |
| PRO | 12.49 | 12.26 | 12.23 |
| CYS | Not Detected | Not Detected | Not Detected |
| TYR | 0.51 | 0.47 | 0.50 |
| OH-LYS | 1.15 | 1.21 | 1.33 |
| VAL | 1.64 | 1.68 | 1.64 |
| MET | 0.63 | 0.60 | 0.60 |
| ORN | 0.09 | 0.09 | 0.15 |
| LYS | 3.66 | 3.56 | 3.30 |
| ILE | 1.54 | 1.52 | 1.48 |
| LEU | 2.73 | 2.67 | 2.61 |
| PHE | 2.04 | 2.00 | 2.02 |

The primary amino acid components in each sample were hydroxy-proline (OH-PRO), proline (PRO), and glycine (GLY). It is believed that these three components play an important role in promoting plant growth.

### Example 2

### Use of Irreversibly Denatured Collagen-Based Gelatin as a Plant Seed Priming Agent

The seed industry typically primes, pre-germinates, and sanitizes seeds using PEG as a substrate. PEG may be used at different molecular weights such as PEG 6000 or PEG 8000, for example. PEG controls the seed imbibition and acts as a diluting agent to other materials in the vicinity of the seed. The following experiments were performed to determine whether irreversibly denatured collagen-based gelatin could be used as a replacement for PEG as a priming agent.

For these experiments, the irreversibly denatured collagen-based gelatin was prepared as described above using the protease, collagenase, peptidase, oxydase and aminase enzymes. The molecular weight of the resulting polypeptides was between about 300 Dalton and about 5000 Dalton.

During the different trials, PEG was replaced both partially and totally with a composition that included irreversibly denatured collagen-based gelatin. It was determined that irreversibly denatured collagen-based gelatin is a suitable priming agent that has the ability to control the imbibition speed and the water availability during the priming, pre-germination, and sanitation processes at the same or similar levels compared to PEG 8000. The irreversibly denatured collagen-based gelatin also advantageously seems to activate the embryos.

Also, when growth regulators, growth promoters, ethephon, ethylene, kinetin's, gibberilic acid, ANA, ABA, Indole Butyric Acid, Naphthalene Acetic Acid, osmotic correctors, salts, acids, fertilizers, were applied along with the irreversibly denatured collagen-based gelatin, the irreversibly denatured collagen-based gelatin reacted produced results similar to when PEG was used.

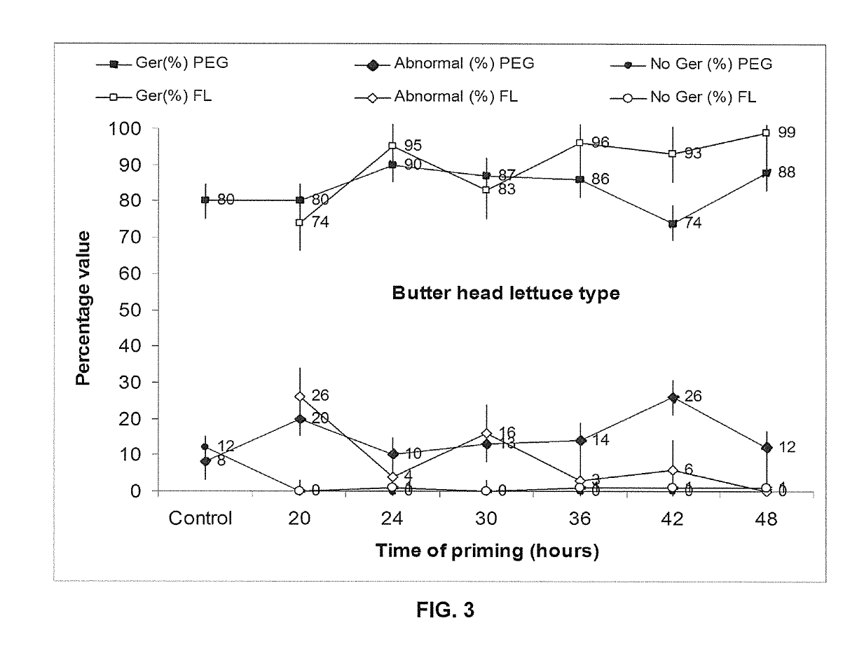

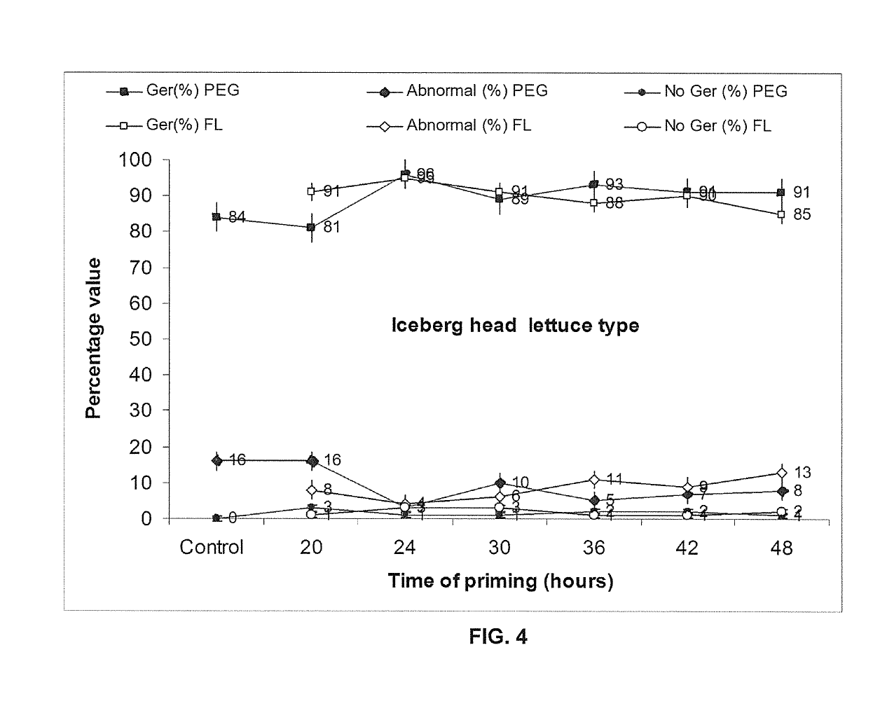

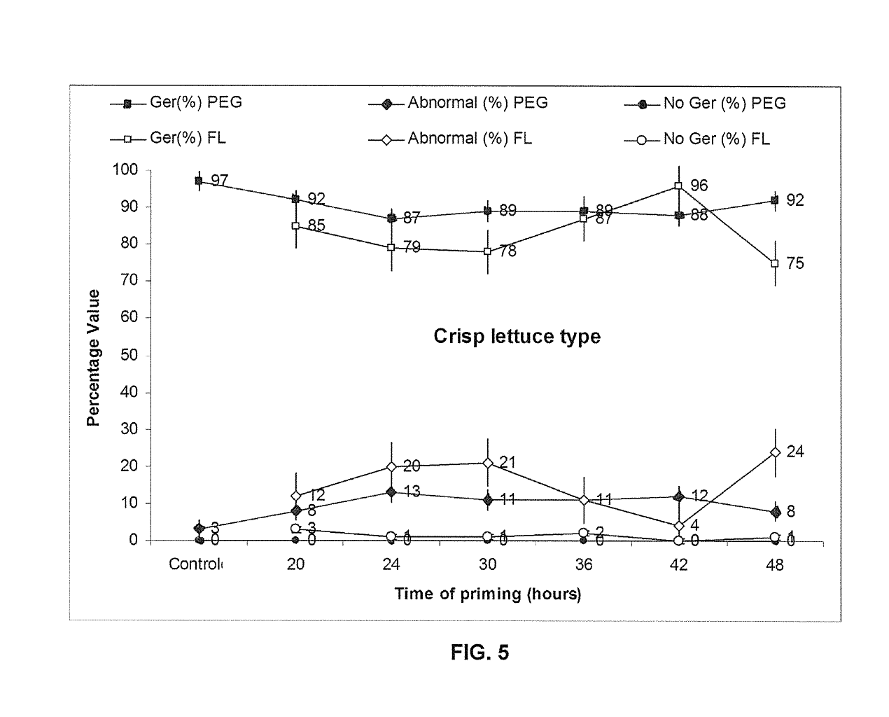

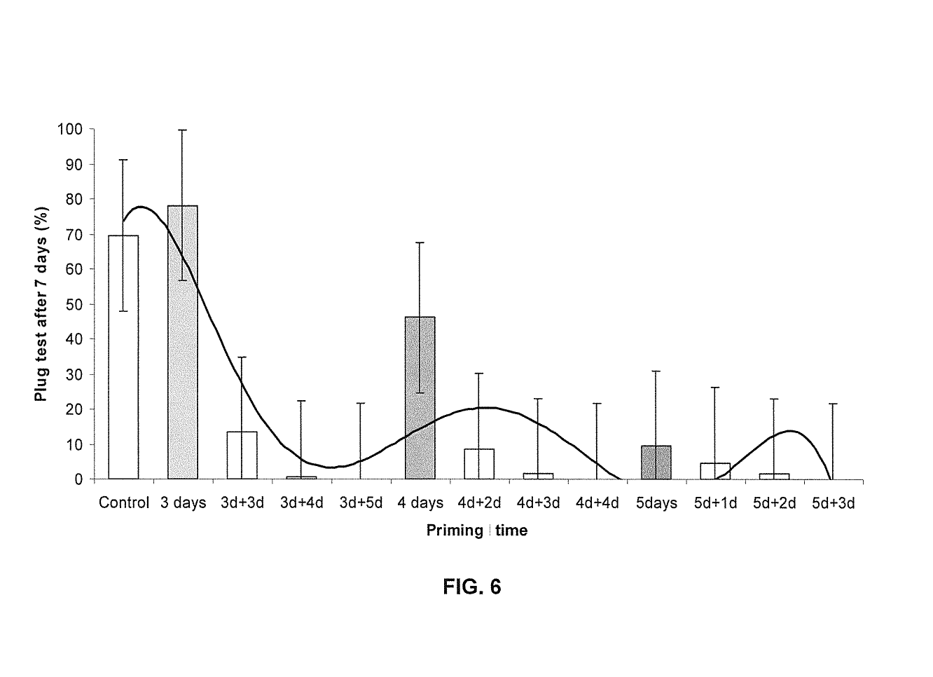

FIGS. 3-5 are graphs comparing the use of PEG versus the irreversibly denatured collagen-based gelatin composition as an osmotic priming agent for three different types of lettuce, namely butter head, crisp, and iceberg. Samples were primed for periods of 20, 24, 30, 36, 42, and 48 hours. A raw seed was used as the control sample. The priming took place in a chamber maintained at 4° C. with bubbling aeration and luminosity.

The graphs compare the percentage of the seeds that germinated(Ger (%)), the % of seeds that were deemed abnormal ((Abnormal (%)), and the percentage of seeds that did not germinate ((No Ger (%)). The data clearly show that the composition of the invention and PEG yield comparable results.

In a different set of experiments a sample of the composition comprising polypeptides in the molecular weight range of about 300 Dalton to about 5000 Dalton were also tried and resulted in similar growth and yield effects.

### Example 3

### Effect of Applying an Irreversibly Denatured Collagen-Based Gelatin Composition at Different Stages of Growth

The experiments discussed in Example 2 were extended to determine whether using the irreversibly denatured collagen-based gelatin as the osmotic primer could influence the long-term growth of the plant.

During the germination-embryonic phase a irreversibly denatured collagen-based gelatin composition of the invention was applied to seeds with enough water to ensure that the polypeptides contacted the seeds. Irreversibly denatured collagen-based gelatin compositions comprising polypeptides having a molecular weight of about 300 Dalton to about 200,000 Dalton were tested. For comparison, a plants that were not primed with irreversibly denatured collagen-based gelatin were also grown.

At a predetermined time during the growth phase of the plants, the irreversibly denatured collagen-based gelatin composition was applied to both categories of plants. The plants that were primed with irreversibly denatured collagen-based gelatin showed a growth enhancement effect when irreversibly denatured collagen-based gelatin was applied at the later stage of plant growth. This means that the growth enhancing effect of the irreversibly denatured collagen-based gelatin can be re-activated with additional application of a irreversibly denatured collagen-based gelatin to the root system of the plant.

In comparison, the plants that were not primed with irreversibly denatured collagen-based gelatin did not show the same sustained growth enhancement effects.

### Example 4

### Priming of Sweet Pepper Seeds

In this example, sweet pepper seeds were primed in a solution of irreversibly denatured collagen-based gelatin, wherein the average molecular weight was between about 300 to about 5000 Dalton. The priming was performed in a 500 mL pot with a bubbling system. The pot was stored in a chamber maintained at 15° C. The seeds were primed for 3, 4, and 5 days without placing them in a drum. A selection of the seeds that were primed from 3, 4, and 5 days were placed into a drum for an additional number of days up to 8 days total. The control sample was a raw un-primed seed of the same variety.

FIG. 6 is a graph of the results from a plug test measured after 7 days from sowing the primed seeds. The dark bars indicate the results of priming for the specified number of days without the drum. By way of example, the indicator 3d+3d means that the seed was primed for three days without the drum and 3 more days inside the drum rotated at 1 rpm. The solid line is a guide to the eye.

These results indicate that after three days of priming a substantial improvement over the control sample was achieved.

### Example 5

### Comparison of Corn Plant Growth Corn Using a Conventional Gelatin Material Versus an Irreversibly Denatured Collagen Based Gelatin Composition of the Invention

In this experiment, the effects on plant growth of a conventional gelatin material compared to a irreversibly denatured collagen-based gelatin composition of the invention were compared. The seed employed in these experiments was hybrid field corn seed P4285H, from Pioneer Seed Company.

Conventional Gelatin Sample (Sample 5-1).

The conventional gelatin sample was prepared with a 200 bloom (approximately) gelatin material obtained from Brazil Sementes e Technologia Ltda in Rio Grande do 5 ul, Brazil. The gelatin was blended for 30 minutes at a rate of 16% w/w gelatin with pelleting powder blend CS-MJ-05, which may be purchased from Coating Supply, Inc., Palm City, Fla. (CSI). This particular pelleting powder has a high content of diatomaceous earth and perlite. Desiccants like gypsum are not necessarily required. Blending was performed in a paddle mixer at 40 rpm. As a polymeric binder for the corn pelleting process, a liquid solution of about 12% w/w polyvinyl acetate, about 7% w/w polyvinyl alcohol (Celvol 603), about 0.01% w/w of TMTD (Thiram), and the remainder water was used.

The total weight in grams of different ingredients used during the process were as follows: (a) 27 kg corn seed or approximately 60,000 seeds; (b) 1.6 kg gelatin; 8.8 kg CS-MJ-05; 0.6 kg polyvinyl acetate; 0.35 kg polyvinyl alcohol.

Irreversibly Denatured Collagen-Based Gelatin Composition Sample (Sample 5-2).

The irreversibly denatured collagen-based gelatin composition sample was prepared by blending the corn seed with 0.01% w/w of TMTD. The polymeric binder used to make the conventional gelatin sample was replaced with re-hydrolyzed gelatin at 16% w/w dissolved in water heated to about 80° C. This temperature was maintained during the pelleting process.

The total weight in grams of different ingredients used during the process were as follows: (a) 27 kg corn seed or approximately 60,000 seeds; (b) 10 kg CS-MJ-05; and 1.6 kg irreversibly denatured collagen-based gelatin.

Pelleting of Samples.

Sample 5-1 and Sample 5-2 were processed in 30″ rotary machine (Seed Pelleting Equipment, Inc., Santa Cruz do 5 ul, Brazil). Each pelleting process was completed in approximately 12 minutes, without sizing the pellets. After completion the samples were placed in a dryer and dried at 34 degrees Celsius for 90 minutes.

It should be noted that Sample 5-1 has 26.6 g of conventional gelatin/1000 seeds of corn. Similarly Sample 5-2 has 26.6 g of re-hydrolyzed gelatin composition/1000 seeds of corn. This is equivalent to 26.6 mg/seed.

Results.

A comparison of the average results of 100 plants from Samples 5-1 and 5-2 that grew for 4 weeks (except for a germination period of 1 week) are provided in Table 2. The plants obtained from Sample 5-2 were substantially heavier, taller, and had thicker stems than the plants obtained from Sample 5-1. In Table 2, weight is the fresh weight.

TABLE 2
Comparison of Corn Plants - 4 weeks

| Sample | Germination % | Stem height | Stem diam. | Weight |
|---|---|---|---|---|
| Sample 5-1 | 97 | 60 cm | 1.5 cm | 22 g |
| Sample 5-2 | 97 | 85 cm | 2.0 cm | 26 g |

A comparison of the average results (in centimeters) of 100 plants from Samples 5-1 and 5-2 70 days from being sewn is provided in Table 3. Notably, the cob width of plants obtained from Sample 5-2 is about 38% larger than for plants obtained from Sample 5-1.

TABLE 3
Comparison of Corn Plants - 70 days after sewing

| | | Stem | | | | | |
|---|---|---|---|---|---|---|---|
| | | Di- | Stem | Leaf | Leaf | Cob | No. of |
| Sample | Height | ameter | Diameter | length | width | width | leaves |
| Sample | 283 | 1.69 | 2.56 | 111.1 | 10.31 | 3.1 | 14.5 |
| 5-1 | | | | | | | |
| Sample | 296 | 2.06 | 3.06 | 117.1 | 10.99 | 4.3 | 15.2 |
| 5-2 | | | | | | | |

During these experiments, it was also observed that the plants obtained from Sample 5-2 appeared greener and healthier than plants obtained from Sample 5-1.

### Example 6

### Comparison of Lettuce Plant Growth Corn Using a Conventional Gelatin Material Versus an Irreversibly Denatured Collagen-Based Gelatin Composition of the Invention

In this experiment, the effects on plant growth of a conventional gelatin material compared to a irreversibly denatured collagen-based gelatin composition of the invention were compared. The seed employed in these experiments was lettuce seed, variety Vanda, from Sakata Seed Sudamerica Ltda.

Conventional Gelatin Sample (Sample 6-1).

The conventional gelatin sample was prepared with a 200 bloom (approximately) gelatin material obtained from Brazil Sementes e Technologia Ltda in Rio Grande do 5 ul, Brazil. The gelatin was blended for 30 minutes at a rate of 2.8% w/w gelatin with pelleting powder blend CS-MJ-05. Blending was performed in a paddle mixer at 40 rpm. REG-510 was used as a pre-coating material. As a polymeric binder for the lettuce seed pelleting process, a liquid solution of about 12% w/w polyvinyl acetate, about 7% w/w polyvinyl alcohol (Celvol 603), about 0.01% w/w of TMTD (Thiram), and the remainder water was used.

The total weight in grams of different ingredients used during the process were as follows: (a) 1 kg lettuce seed or approximately 980,000 seeds; (b) 0.75 kg gelatin; 26 kg CS-MJ-05; 0.6 kg polyvinyl acetate; 0.35 kg polyvinyl alcohol; and 5 kg REG 510M. The individual seed pellets were about 3 to 3.5 mm in diameter.

Irreversibly Denatured Collagen-Based Gelatin Composition Sample (Sample 6-2).

The irreversibly denatured collagen-based gelatin composition sample was prepared by blending the lettuce seed with 0.01% w/w of TMTD (Thiram). REG 510M was used as a pre-coating material. The polymeric binder used to make the conventional gelatin sample was replaced with re-hydrolyzed gelatin at 15% w/w dissolved in water heated to about 80° C. This temperature was maintained during the pelleting process.

The total weight in grams of different ingredients used during the process were as follows: (a) 1 kg lettuce seed or approximately 980,000 seeds; (b) 0.75 kg gelatin; 26 kg CS-MJ-05; 5 kg REG 510M; and 1.6 kg irreversibly denatured collagen-based gelatin composition. The individual seed pellets were about 3 to 3.5 mm in diameter.

Pelleting of Samples.

Samples 6-1 and 6-2 were pre-coated individually using a standard coating pan (100 mm diameter) from Seed Pelleting Equipment Inc., Santa Cruz do Sul, Brazil to apply 5 kg of REG-510M to produce a mini pellet. Then, the lettuce mini pellets were moved to a 30″ rotary machine. The coating pan process was completed in 15 minutes and the rotary phase of the process was completed in approximately 25 minutes. The pellets were sized to about 3.0-3.50 mm diameter. The sized pellets were placed in a dryer and dried at 34° C. for 120 minutes.

It should be noted that that 0.76 g of conventional gelatin/1000 seeds were used in Sample 6-1 and 0.76 g of irreversibly denatured collagen-based gelatin composition/1000 seeds were used in Sample 6-2.

Both samples were processed in conventional seed coating and pelleting machinery. The samples were dried using conventional cabinet dryers to a final absolute moisture content of about 2.5% for each pellet.

Results.

A comparison of the average results of 100 plants from Samples 6-1 and 6-2 that grew for 4 weeks (except for a germination period of 1 week) are provided in Table 4. The plants obtained from Sample 6-2 were substantially healthier, had thicker leaves, and were substantially greener than the plants obtained from Sample 6-1.

TABLE 4
Comparison of Corn Plants - 4 weeks

| Sample | Germination % | Stem height | Health | Green Color |
|---|---|---|---|---|
| Sample 6-1 | 97 | 60 cm | good | green |
| Sample 6-2 | 98 | 85 cm | very good | very green |

### Example 7

### Effect of Fungicide and Fertilizer on the Harvest Yield of Tomato Plants

In this set of experiments, the harvest yield from planted tomato plant seeds were compared. The tomato variety was Debora Pto from Sakata Corporation. The tomato plant seeds were divided into four categories. The “control” group included tomato seeds that were not treated with irreversibly denatured collagen-based gelatin. The “capsule” group included tomato seeds that were placed inside a hollow capsule comprising irreversibly denatured collagen-based gelatin. The “capsule+trifung” group included tomato seeds that were placed inside a hollow capsule comprising irreversibly denatured collagen-based gelatin along with “trifung”, which was a composition of three fungicides. The “capsule+trifung+fertilizer” group was the same as the “capsule+trifung” group, except that 12 mg of NPK 4-14-8 fertilizer were placed inside the capsule as well.

The ingredients in the composition referred to as “trifung” are provided in Table 5. It included the seed pelleting powder Floors 18 (Coating Supply, Inc.) and CS-MJ-05 (Coating Supply, Inc.). It further included irreversibly denatured collagen-based gelatin. The Amistar micropellet was coated with the remaining ingredients as if it were a seed being coated. The filmcoat polymer was applied to the resulting pellet.

TABLE 5
Ingredients in Trifung

| Ingredient | Quantity/#pellets |
|---|---|
| Amistar (Azostrobin 500 g/kg) micropellet | 64 g/million |
| Ridomil Gold MZ | 2 kg/million |
| (Mancozeb 640 g/kg + Metalaxil M 40 g/kg)) | |
| Maxim (fludioxonil 25 g/l) | 145 ml/million |
| Floors 18 (until 1.5 mm diameter) | 5 g/1000 |
| CSMJ05 | 21 g/1000 |
| Irreversibly denatured collagen-based gelatin | 1.2 g/1000 |
| Filmcoat polymer | 135 ml/million |

Each sample was initially sown and later transplanted about 1 month later. The tomato plants that grew from each sample were harvested about 3.5 months from the time the seeds were sown. 100 plants per category were tested.

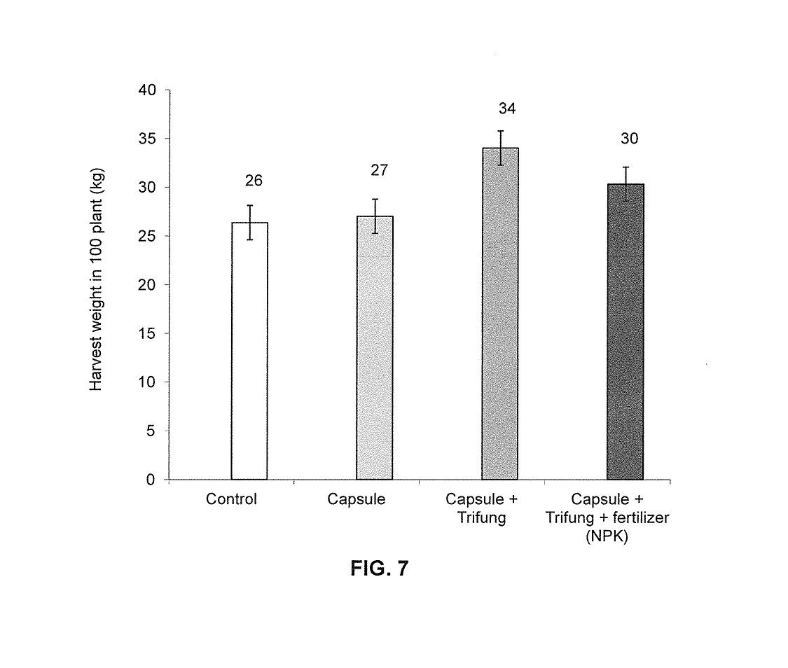

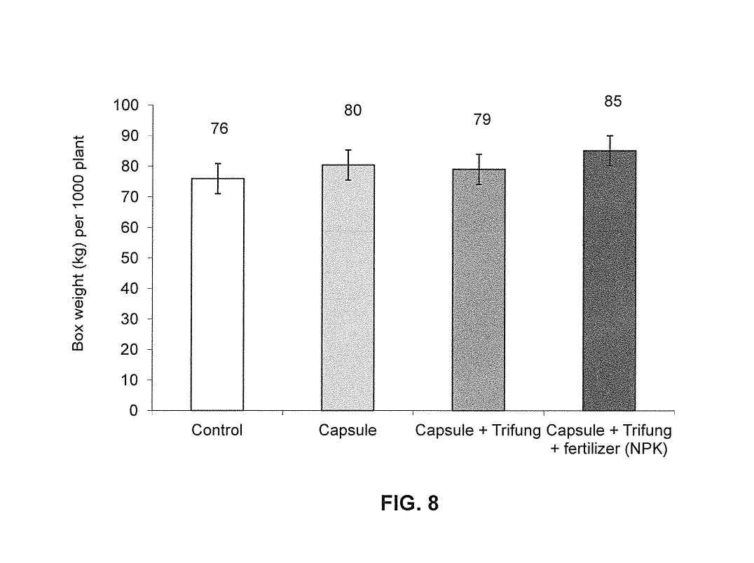

FIG. 6 is a bar graph showing the results from the first tomato harvest. FIG. 7 is a bar graph of the box weight per 1000 plants after a total of four harvests. It is clear from these data that the samples in which an irreversibly denatured collagen based gelatin capsule was used, the yield was significantly improved relative to the control group.

The invention has been described above with reference to the accompanying drawings, in which preferred embodiments of the invention are shown. Unless otherwise defined, all technical and scientific terms used herein are intended to have the same meaning as commonly understood in the art to which this invention pertains and at the time of its filing. Although various methods and materials similar or equivalent to those described herein can be used in the practice or testing of the present invention, suitable methods and materials are described. The skilled should understand that the methods and materials used and described are examples and may not be the only ones suitable for use in the invention.

Any publications, patent applications, patents, and other references mentioned herein are incorporated by reference in their entirety as if they were part of this specification. However, in case of conflict, the present specification, including any definitions, will control.

In the specification set forth above there have been disclosed typical preferred embodiments of the invention, and although specific terms are employed, the terms are used in a descriptive sense only and not for purposes of limitation. The invention has been described in some detail, but it will be apparent that various modifications and changes can be made within the spirit and scope of the invention as described in the foregoing specification and as defined in the appended claims.

1. A covered plant propagation source product comprising a plant propagation source covered by a covering material, the covering material comprising irreversibly denatured collagen-based gelatin.

2. The covered plant propagation source product of claim 1, wherein the plant propagation source is one or more plant seeds.

3. The covered plant propagation source product of claim 1, wherein the plant propagation source is one or more plant embryos.

4. The covered plant propagation source product of claim 1, wherein the covering material comprises a coating over the plant propagation source.

5. The covered plant propagation source product of claim 1, wherein the covering material is a hollow capsule.

6. The covered plant propagation source product of claim 1, wherein the covering material allows water to transport the irreversibly denatured collagen-based gelatin in such a way that the irreversibly denatured collagen-based gelatin contacts the plant propagation source.

7. The covered plant propagation source product of claim 1, wherein the covering material further comprises fertilizer, fungicide, insecticide, growth promoter, hormone, marker or a combination thereof.

8. The covered plant propagation source product of claim 1, wherein the covering material further comprises protease enzymes, collagenase enzymes, peptidase enzymes, oxidase enzymes, aminase enzymes, or combinations thereof, the enzymes being effective for denaturing gelatin.

9. The covered plant propagation source product of claim 1, wherein the irreversibly denatured collagen-based gelatin has an average molecular weight of between about 300 to about 200,000 Dalton.

10. The covered plant propagation source product of claim 1, wherein the irreversibly denatured collagen-based gelatin has an average molecular weight of between about 300 to about 5000 Dalton.

11. A method of making a covered plant propagation source product, the method comprising:
covering one or more plant propagation sources with a covering composition comprising irreversibly denatured collagen-based gelatin.

12. The method of claim 11, wherein the plant propagation source is one or more plant seeds.

13. The method of claim 11, wherein the plant propagation source is one or more plant embryos.

14. The method of claim 11, wherein obtaining comprises heating non-denatured collagen-based gelatin to a temperature sufficient to form irreversibly denatured collagen-based gelatin.

15. The method of claim 14, further comprising heating the irreversibly denatured collagen-based gelatin to further denature the collagen-based gelatin's native protein structure.

16. The method of claim 11, wherein obtaining comprises contacting non-denatured collagen-based gelatin with protease enzymes, collagenase enzymes, peptidase enzymes, oxidase enzymes, aminase enzymes, or a combination thereof.

17. The method of claim 11, wherein obtaining comprises heating non-denatured collagen-based gelatin to a temperature sufficient to form irreversibly thermally denatured collagen-based gelatin and subsequently contacting the irreversibly thermally denatured collagen-based gelatin with protease enzymes, collagenase enzymes, peptidase enzymes, oxidase enzymes, aminase enzymes, or a combination thereof.

18. The method of claim 11, wherein covering comprises placing the one or more plant propagation sources into a hollow capsule, the hollow capsule being formed from the covering composition.

19. The method of claim 11, wherein covering comprises coating the one or more plant propagation sources with the covering material by blending one or more plant seeds with the covering material in the presence of water.

20. A method of promoting plant growth, the method comprising contacting one or more plant propagation sources with irreversibly denatured collagen-based gelatin prior to or during germination of the one or more plant propagation sources.

21. The method of claim 20, wherein the one or more plant propagation sources are one or more plant seeds.

22. The method of claim 20, wherein the one or more plant propagation sources are one or more plant embryos.

23. The method of claim 20, wherein contacting comprises soaking the one or more plant propagation sources in irreversibly denatured collagen-based gelatin prior to sowing the one or more plant propagation sources.

24. The method of claim 20, further comprising contacting a plant that grows from the one or more plant propagation sources with irreversibly denatured collagen-based gelatin.

25. The method of claim 20, further comprising, in a subsequent step, covering the one or more plant propagation sources in a covering material comprising irreversibly denatured collagen-based gelatin prior to sowing the one or more plant propagation sources.

26. The method of claim 25, wherein the covering material further comprises fertilizer, fungicide, insecticide, growth promoter, hormone, marker, or a combination thereof.

27. The method of claim 20, wherein the irreversibly denatured collagen-based gelatin has an average molecular weight of between about 300 to about 200,000 Dalton.

28. The method of claim 20, wherein the irreversibly denatured collagen-based gelatin has an average molecular weight of between about 300 to about 5,000 Dalton.

29. A method of making a seed pellet with a plant seed therein, the method comprising:
coating the seed with a coating composition comprising irreversibly denatured collagen-based gelatin and a seed coating powder by wetting the seed coating powder such that the seed coating powder adheres to the seed to form a coated seed; and
allowing the coated seed to dry.

30. The method of claim 29, wherein coating composition is present in a solid form during coating.

31. The method of claim 29, wherein wetting is achieved by applying a solution of the coating composition to the seed coating powder.
